(19) United States
(12) Patent Application Publication
(10) Pub. No.: US 2025/0297896 A1
(43) Pub. Date: Sep. 25, 2025

(54) SLOT DEVICE

(71) Applicant: Fulian Precision Electronics ( Tianjin ) Co., Ltd., Tianjin (CN)

(72) Inventors: CHIA-YI WU, New Taipei (TW); Yun-Cheng Hsieh, New Taipei (TW)

(21) Appl. No.: 18/963,902

(22) Filed: Nov. 29, 2024

Related U.S. Application Data
(60) Provisional application No. 63/568,517, filed on Mar. 22, 2024.

(51) Int. Cl. G01K 1/143; G01K 1/08; G01K 13/00; G06F 1/18

(52) U.S. Cl. CPC G01K 1/143; G01K 1/08; G01K 13/00; G06F 1/185

(57) ABSTRACT

A slot device is disclosed in the present application. The slot device includes a slot body and a sensor assembly, the sensor assembly is disposed in the slot body and used to obtain the sensing data of the object inserted into the slot body. The sensor assembly has a first surface close to the object; the slot body is provided with a protective portion, and the protective portion is arranged on the slot body around the sensor assembly. The height of the protective portion in the first direction is less than or equal to the height of the sensor assembly in the first direction, and the first direction is the direction perpendicular to the first surface. The slot device can protect the sensor assembly and has low cost.

### FIELD

The present application relates to the field of electronic devices, and particularly to a slot device.

### BACKGROUND

Usually, after inserting a memory into a motherboard slot, a temperature sensor is needed to monitor its temperature, and the closer the temperature sensor is to the memory, the more accurate the monitoring data will be. The memory is frequently plugged and unplugged and can easily cause friction or collision with the temperature sensor, causing the temperature sensor to be damaged or malfunction. Related art can use a very precise and appropriately sized motherboard slot to install the temperature sensor, to reduce the friction and collision of the temperature sensor when the memory is plugged and unplugged. However, this method is not guaranteed to reduce the friction and collision, the process requirements are high, and the cost is high.

Therefore, improvement is desired.

### BRIEF DESCRIPTION OF THE DRAWINGS

Implementations of the present application will now be described, by way of embodiments, with reference to the attached figures.

FIG. 1 is a schematic diagram of inserting a memory card into a motherboard slot.

FIG. 2 is a schematic diagram of an embodiment of a slot device of the present application.

FIG. 3 is a schematic diagram of an embodiment of the slot device inserting an object of the present application.

FIG. 4 is a three-dimensional view of the slot device of the present application.

FIG. 5 is an exploded view of the slot device of FIG. 4.

FIG. 6 is a cross-sectional view of the slot device of FIG. 4.

FIG. 7 is a schematic diagram of an embodiment of a circuit board of the slot device of the present application.

FIG. 8 is a schematic diagram of an embodiment of a slot body of the slot device of the present application.

### DETAILED DESCRIPTION

The technical solutions in the embodiments of the present application will be described below in conjunction with the accompanying drawings in the embodiments of the present application, and the described embodiments are only a portion of the embodiments of the present application and not all of the embodiments.

In the description of the embodiments of the present application, the terms “exemplary”, “or”, and “for example” are used to indicate examples, illustrations, or descriptions.

In the embodiment of the present application, the words “first” and “second” are only used to distinguish different objects and cannot be understood as indicating or implying relative importance, or as indicating or implying order.

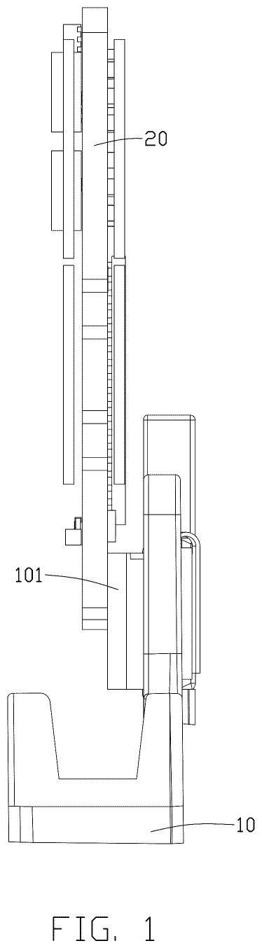

FIG. 1 illustrates a scenario where a memory card 20 is inserted into a motherboard slot 10.

When the integrated circuit (IC) of the memory card 20 is at non-operating temperature, there may be a risk of operating errors. Therefore, the memory card 20 needs to be temperature monitored using a temperature sensor 101 after it is inserted into the motherboard slot 10 (i.e., the slot device of the motherboard), and the motherboard or the entire system will allow the memory card 20 to operate only when the temperature of the memory card 20 is in the range of the operating temperature. The closer the temperature sensor 101 is to the memory stick 20 to monitor the data, the more accurate it is, preferably with a tight contact. Referring to FIG. 1, the surface of the memory card 20 is not a flat surface, and the memory card 20 needs to be frequently plugged and unplugged during use, and the relative positions of the temperature sensor 101 and the memory card 20 are fixed, which can easily cause friction or collision between the memory card 20 and the temperature sensor 101, and may result in damage to the temperature sensor 101 or the memory card 20. Related art can use a very precise and appropriately sized motherboard slot to install the temperature sensor, to reduce the friction and collision of the temperature sensor when the memory is plugged and unplugged. However, this method is not guaranteed to reduce the friction and collision.

The present application provides a slot device that can protect a sensing assembly at a low cost.

Embodiments of the present application will be described below in connection with the accompanying drawings.

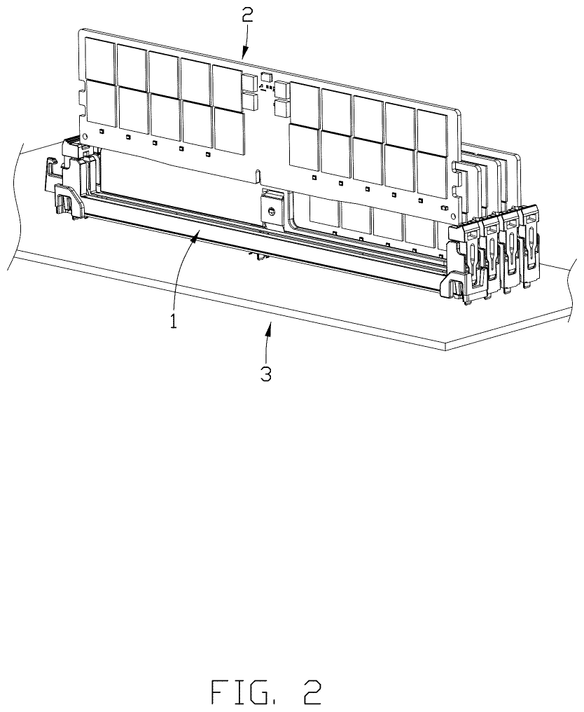

FIG. 2 illustrates a slot device 1 in accordance with an embodiment of the present application.

The slot device 1 can be installed on a computer motherboard or on a test device 3, and the slot device 1 can be used for insertion of the memory card 20 or other objects that need to be used for use in the computer motherboard or the test set 3. The slot device 1 may have slots that match dual inline memory module (DIMM) memory cards or single inline memory module (SIMM) memory cards. The memory cards or other objects that need to be used for use in the computer motherboard or the test device 3 are collectively referred to the object 2.

In some embodiments, the object 2 may include a DIMM memory card or a SIMM memory card. The object 2 may also include other types of memory cards.

In some embodiments, referring to FIG. 2, corresponding to the number of the objects 2, the slot device 1 may be a plurality. For example, on the computer motherboard or in the test device 3, when n objects 2 need to be plugged in, the slot device 1 can correspond to 1, 2, 3 . . . n, where n is a positive integer. Therefore, the computer motherboard or the test device 3 can utilize the plurality of the slot devices 1 to plug in a plurality of the objects 2 and perform data reading or performance testing of the plurality of the objects 2, thereby enhancing work efficiency.

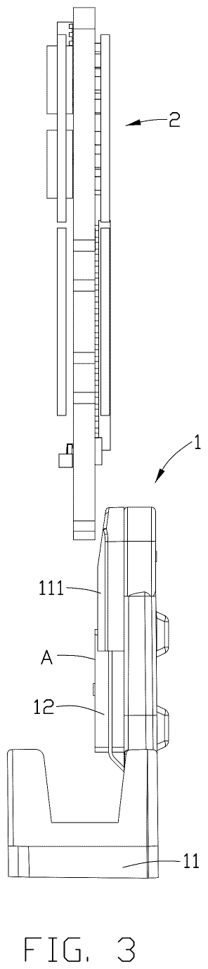

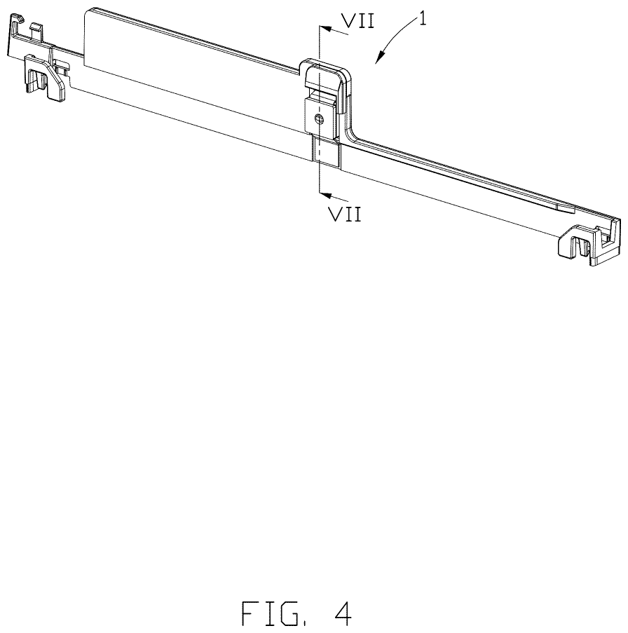

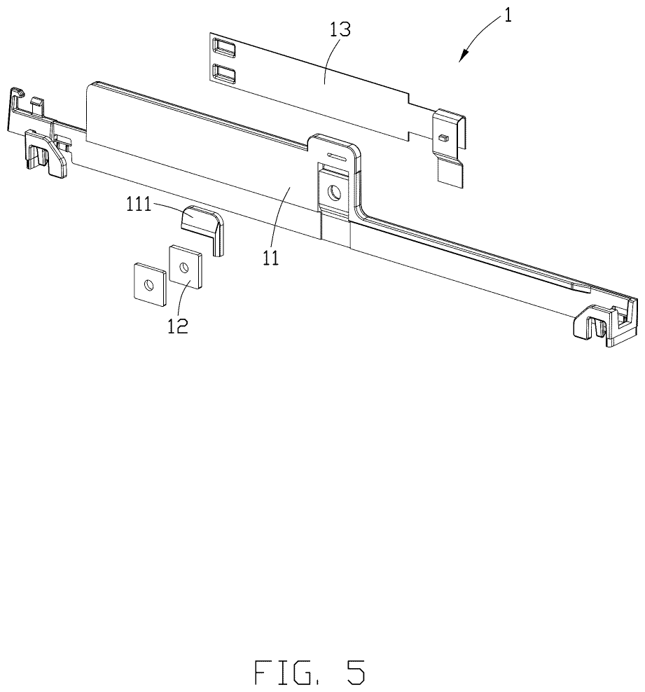

FIG. 3 is a schematic diagram of a scenario where the slot device 1 of the present application is plugged into the object 2. FIG. 4 is a three-dimensional diagram of the slot device 1 of the present application. FIG. 5 is an exploded view of the slot device 1 of FIG. 4.

Referring to FIGS. 3 to 5, the slot device 1 includes a slot body 11 and a sensor assembly

12. The slot body 11 may be used to insert the object 2, the sensor assembly 12 may be disposed on the slot body 11 and used to obtain sensing data of the object 2 inserted in the slot body 11, and the sensor assembly 12 has a first surface A close to the object 2.

In the embodiment, referring to FIG. 3, the slot body 11 may be provided with a protective portion 111, the protective portion 111 is disposed around the sensor assembly 12 on the slot body 11, and a height of the protective portion 111 in a first direction is less than or equal to a height of the sensor assembly 12 in the first direction. The present application can protect the sensor assembly 12 when the object 2 is inserted in the slot device 1 and reduce the friction and collision between the object 2 and the sensor assembly 12 by providing a protective portion 111 around the sensor assembly 12 on the slot body 11. Since the height of the protective portion 111 in a direction perpendicular to the first surface A is less than or equal to the height of the sensor assembly 12 in a direction perpendicular to the first surface A, the sensor assembly 12 can still be close to the object 2 after the object 2 is inserted in the slot device 1, thus the sensor assembly 12 can be protected without affecting the operation of the sensor assembly 12.

In some embodiments, the first direction may be a direction perpendicular to the first surface A.

In some embodiments, as shown in FIG. 4 or FIG. 5, the protective portion 111 has an “L” shape, and the long and short sides of the protective portion 111 are disposed around the sensor assembly 12.

In some embodiments, the sensor assembly 12 includes a sensor 121, the sensor 121 is located at the center of the sensor assembly 12, and a width of the protective portion 111 can be more than twice a width of the sensor 121.

In some embodiments, the sensor 121 may be a temperature sensor, and the sensing data can be temperature sensing data. The sensor 121 can be a semiconductor temperature sensor, such as a temperature sensor based on bipolar junction transistor (BJT).

In another embodiments, the sensor 121 may also be various types of sensors other than temperature sensors, such as stroke sensors, current sensors, or position sensors. The sensing data may be data such as travel, electrical parameter or position.

In some embodiments, the sensor assembly 12 may include at least one connection member having thermal and electrical conductivity. The connection member may be disposed in an accommodation portion 131 and at least partially disposed on a side of the accommodation portion 131 away from the slot body 11, the connection member is used to connect the sensor assembly 12 and a circuit board 13.

In some embodiments, the connection member may be copper, silver, gold, or other metals or alloys with good thermal and electrical conductivity. The connection member may be set as a Via hole or a Pad hole to connect the sensor 121 and the flexible circuit board. Thus, the circuit connection between the sensor 121 and the flexible circuit board can be achieved.

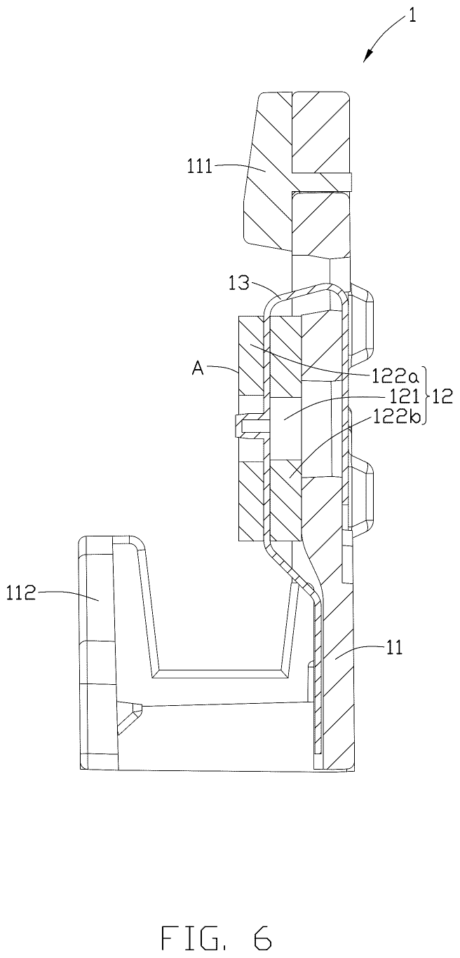

FIG. 6 is a cross-sectional view of the slot device 1 of FIG. 4.

In some embodiments, referring to FIG. 6, the long side of the protective portion 111 may have an inclined surface, the inclined surface is a side close to the object 2 inserted into the slot body 11. The protective portion 111 can be set as a guide angle, which can play a certain guiding role during the process of inserting the object 2 into the slot body 11.

Referring to FIG. 5, the slot device 1 further includes a circuit board 13, and the circuit board 13 is disposed in the slot body 11. The circuit board 13 is connected to the sensor assembly 12, and the sensor assembly 12 can be connected to the controller of the test device 3 through the circuit board 13 after acquiring the sensing data of the object 2, so as to transmit the sensing data to the controller through the circuit board 13 for data processing.

In some embodiments, the circuit board 13 may be a flexible circuit board, which is a highly reliable and excellent flexible printed circuit board made of polyimide or polyester film as the substrate. In other words, the flexible circuit board of the present application may have a certain degree of elasticity or deformability. In this case, the elasticity or deformability of the flexible circuit board can be utilized to provide some cushioning when the object 2 is inserted in the slot device 1 and contacts with the sensor assembly 12, thereby reducing the risk of damage to the sensor assembly 12.

In some embodiments, the circuit board 13 may be constructed by embedding circuit elements in a bendable sheet of lightweight plastic. The circuit elements in the circuit board 13 may enable the sensor assembly 12 to be connected to the motherboard or the test device 3, this can thereby facilitate the sensor assembly 12 to transmit the sensing data to the motherboard or the test device 3 through the circuit board 13.

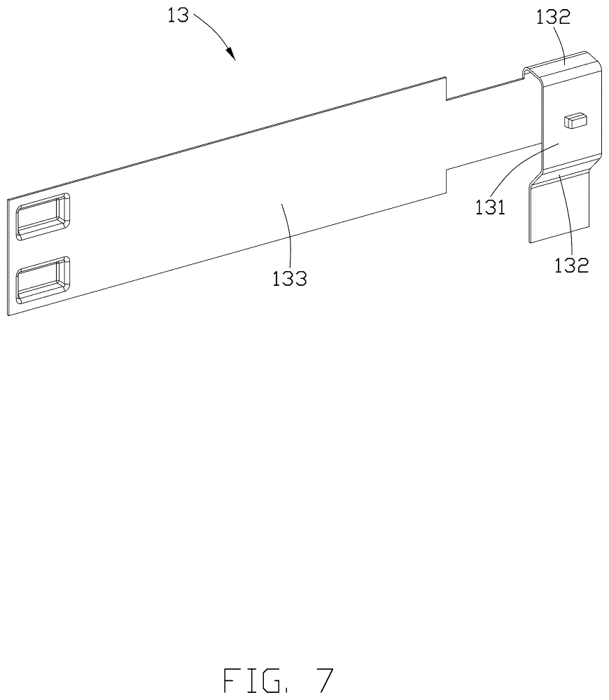

FIG. 7 is a schematic diagram of the circuit board 13 of the slot device 1 of the present application.

In some embodiments, referring to FIG. 7, the circuit board 13 includes an accommodation portion 131, the accommodation portion 131 is formed by bending at least a portion of the circuit board 13, and the accommodation portion 131 is used to accommodate the sensor assembly 12. As described above, the sensor assembly 12 may include a sensor 121, and the accommodation portion 131 is used to accommodate the sensor 121.

In some embodiments, the position where the accommodation portion 131 accommodates the sensor 121 may have a through hole, the through hole may be used to fix the sensor 121 and for the sensor 121 to pass through. As a result, it may be convenient for the sensor 121 to be close to the object 2 to obtain more accurate sensing data.

In some embodiments, referring to FIG. 7, the circuit board 13 further includes a partition plate 132 and a base plate 133. The accommodation portion 131 and the partition plate 132 may form a containment structure, the containment structure may be used to receive the sensor assembly 12, and the sensor assembly 12 may be disposed in the accommodation portion 131 and located on a side of the accommodation portion 131 close to the slot body 11. As a result, the sensor assembly 12 can be stabilized in the containment structure formed by the accommodation portion 131 and the partition plate 132.

In some embodiments, the base plate 133 of circuit board 13 can be designed to adhere to the slot body 11. In some embodiments, the base plate 133 of the circuit board 13 may define a positioning groove, and the slot body 11 may have a positioning protrusion that match the positioning groove of the base plate 133. As a result, the 13 can be quickly and accurately installed on the slot body 11 by means of the positioning groove and the positioning projection, thereby enhancing the installation efficiency.

In some embodiments, the accommodation portion 131 and the partition plate 132 may be formed by extending and bending the base plate 133. More specifically, the accommodation portion 131 and the partition plate 132 may be a part of the base plate 133 that passes through a hollow area of the slot body 11 and is bent in the same direction as the insertion direction of the object 2.

In the embodiment, the accommodation portion 131 is used to set the sensor assembly 12 and to be close to the object 2 after the object 2 is inserted; the partition plate 132 is used to counteract the friction and collision of the object 2 during the insertion of the object 2, and can accordingly telescope and deform to change the position of the sensor assembly 12 disposed on the accommodation portion 131, thereby further providing effective protection for the sensor assembly 12.

As mentioned above, the partition plate 132 can be formed in the same direction as the insertion direction of the object 2 in the accommodating portion 131. In some embodiments, the partition plate 132 may have a preset tilt angle, for example, the preset tilt angle may be 45°, 60°, or 75°, etc. The preset tilt angle may be an angle range of 0° to 90°.

The circuit board 13 of the present application can be made of materials including insulating film, conductor, and adhesive. The insulating film may be used as a protective cover to isolate circuits from dust and moisture, and to reduce stress during bending. The conductor may be used to form conductive layers. The adhesive may be used to bond the insulating film to the conductive layer. The insulating film can be made of polyimide and polyester materials, and the conductor can include copper foil, which is formed in the insulating film by electrodeposition (ED) or plating method.

In some embodiments, the material of the circuit board 13 may not include adhesive. In the circuit board 13, the stacked layers without adhesive can form thinner circuits with greater flexibility. The present application has a better thermal conductivity compared to a stacked layer construction using an adhesive as a base. In this case, due to the thin structure characteristics of adhesive free flexible circuits and the elimination of the thermal resistance of adhesives, the thermal conductivity is improved, the deformation and high thermal conductivity characteristics of the circuit board 13 can thus be utilized to protect the sensor assembly 12, while also enhancing the accuracy of the sensing data acquired by the sensor assembly 12.

In some embodiments, referring to FIG. 6, the sensor assembly 12 may also include a first clamping member 122a and a second clamping member 122b, the first clamping member 122a is disposed on the circuit board 13 and located on the side of the circuit board 13 close to the slot body 11, and the second clamping member 122b is disposed on the circuit board 13 and located on the side of the circuit board 13 away from the slot body 11, the first clamping member 122a cooperates with the second clamping member 122b to secure the sensor 121 to the accommodation portion 131.

In some embodiments, the width of the protective portion 111 is greater than the width of the first clamping member 122a or the width of the second clamping member 122b, and the width of the protective portion 111 is more than twice the width of the sensor 121.

In some embodiments, the first clamping member 122a and the second clamping member 122b may be objects having a certain degree of elasticity, such as non-conductive springs, sponges, silicone pads, or other elastic objects.

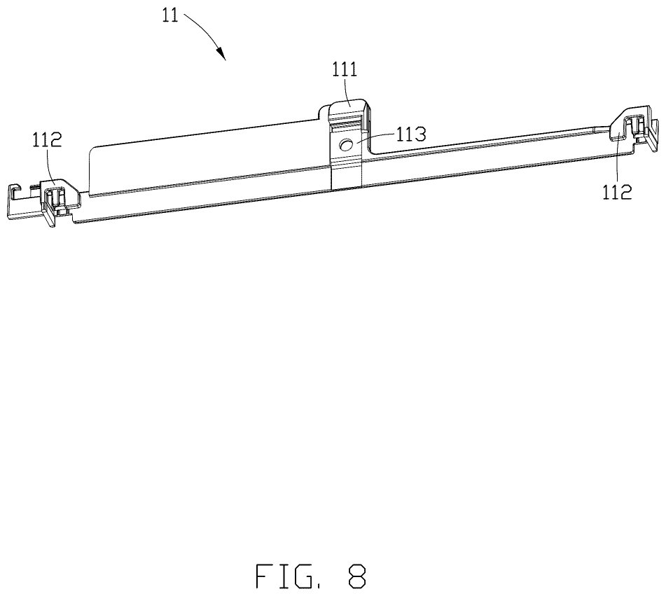

FIG. 8 is a schematic diagram of the slot body 11 of the slot device 1 of the present application.

In some embodiments, referring to FIG. 8, the slot body 11 may have a placing portion 113 in the shape of a groove or hollow, and at least a portion of the flexible circuit board may be disposed in the placing portion 113. More specifically, the accommodation portion 131 of the circuit board 13 and the sensor assembly 12 may be disposed at the placing portion 113, and the accommodation portion 131 and the partition plate 132 may be portions disposed in the placing portion 113. In this case, the flexible circuit board is placed in the placing portion 113, which can reduce the overall weight and space occupation of the slot device 1, thereby reducing costs and saving space for arranging more slot devices 1 on the computer motherboard or the test device 3.

In some embodiments, the slot body 11 may be in the shape of a long plate, and a long side portion of the slot body 11 extends in the direction of a plate surface of the long plate, and then extends parallel to the plate surface of the long plate to form a hook portion 112. In the embodiment, the hook portion 112 may be used as a slot for inserting the object 2.

In some embodiments, a portion of the long plate surface of the slot body 11 has a larger area than the remaining portion. The portion with a larger area can be used to install the sensor assembly 12 and the flexible circuit board, while the portion with a smaller area can be used to optimize space utilization and reduce the weight of the slot body 11.

In another embodiment, the slot device 1 may also include a slot portion, a fixing portion, and a circuit connection portion. The slot portion can be used to form a slot, the slot portion is in the form of an elongated rectangular body, the rectangular body can form a groove that matches the shape of the object 2. In the embodiment, the hook portion 112 of the slot body 11 can be used to install and fix the slot portion. The hook portion 112 does not need to be used as a slot for inserting the object 2. The slot for inserting the object 2 is formed by a rectangular slot portion.

In some embodiments, the fixing portion may be disposed in the slot portion and used to cooperate with the slot portion to fix the object 2 inserted in the slot. The fixing portion may be disposed at both ends of the slot portion. The fixing portion may be a snap mechanism disposed at both ends of the slot portion. The present application can frame the object 2 inserted into the slot and enhance the stability of the object 2 inserted into the slot device 1 through the cooperation between the slot body 11, the slot portion, and the fixing portion.

In some embodiments, the circuit connection portion may be disposed in the slot of the slot portion, and the circuit connection portion may be used to electrically connect the motherboard and the object 2. The circuit connection portion may be disposed in the slot of the slot portion and may contact the conductive contacts (commonly known as “golden fingers”) of the object 2 when the object 2 is inserted into the slot. As a result, the motherboard is electrically connected to the object 2 through the circuit connection portion.

In some embodiments, the slot body 11, the slot portion, and the fixing portion can be made of non-metallic materials, while the circuit connection portion can be made of conductive metal materials.

The present application can protect the sensor assembly 12 when the object 2 is inserted in the slot device 1 and reduce the friction collision between the object 2 and the sensor assembly 12 by providing the protective portion 111 around the sensor assembly 12 on the slot body 11. Since the height of the protective portion 111 in a direction perpendicular to the first surface A is less than or equal to the height of the sensor assembly 12 in a direction perpendicular to the first surface A, the sensor assembly 12 can still be close to the object 2 after the object 2 is inserted in the slot device 1, thus the sensor assembly 12 can be protected without affecting the operation of the sensor assembly 12. The sensor assembly 12 is protected by the protective portion 111, and the structural design is simple, which can reduce the cost.

Even though numerous characteristics and advantages of the present technology have been set forth in the foregoing description, together with details of the structure and function of the present application, the application is illustrative only, and changes can be made in the detail, especially in matters of shape, size, and arrangement of the parts within the principles of the present application, up to and including the full extent established by the broad general meaning of the terms used in the claims. It will, therefore, be appreciated that the exemplary embodiments described above can be modified within the scope of the claims.

What is claimed is:

1. A slot device comprising a slot body and a sensor assembly, wherein:
the slot body is configured for inserting an object;
the sensor assembly is installed on the slot body to obtain sensing data of the object inserted into the slot body, and the sensor assembly comprises a first surface close to the object; and
the slot body is provided with a protective portion, the protective portion is disposed around the sensor assembly in the slot body, a height of the protective portion in a first direction is less than or equal to a height of the sensor assembly in the first direction, and the first direction is perpendicular to the first surface.

2. The slot device according to claim 1, wherein a long side and a short side of the protective portion are arranged around the sensor assembly.

3. The slot device according to claim 2, wherein the long side of the protective portion has an inclined surface, and the inclined surface is a surface close to the object inserted into the slot body.

4. The slot device according to claim 1, wherein the slot device further comprises a circuit board, the circuit board is disposed on the slot body, and the circuit board is electrically connected to the sensor assembly.

5. The slot device according to claim 4, wherein the circuit board comprises an accommodation portion, the accommodation portion is formed by bending at least a part of the circuit board, the sensor assembly comprises a sensor, and the accommodation portion is configured to accommodate the sensor.

6. The slot device according to claim 5, wherein the slot body is provided with a placing portion, and the sensor assembly and the accommodation portion are disposed on the placing portion, and the placing portion has a groove or hollow shape.

7. The slot device according to claim 5, wherein the sensor assembly further comprises a first clamping member and a second clamping member, the first clamping member is disposed on the circuit board and located on a side of the circuit board close to the slot body, the second clamping member is disposed on the circuit board and located on a side of the circuit board away from the slot body, the first clamping member cooperates with the second clamping member to secure the sensor to the accommodation portion.

8. The slot device according to claim 7, wherein a width of the protective portion is greater than a width of the first clamping member or the second clamping member and more than twice the width of the sensor.

9. The slot device according to claim 1, wherein the slot body comprises a slot portion, the slot portion is in a form of an elongated rectangular body, the slot portion defines a slot for matching the object.

10. The slot device according to claim 9, wherein the slot body comprises a fixing portion, the fixing portion is disposed at both ends of the slot portion, and the fixing portion is configured to cooperate with the slot portion to fix the object inserted into the slot.

11. A slot device comprising a slot body and a sensor assembly, wherein:
the slot body is configured for inserting an object;
the sensor assembly is installed on the slot body to obtain sensing data of the object inserted into the slot body, and the sensor assembly comprises a first surface close to the object; and
the slot body is provided with a protective portion, the protective portion is disposed around the sensor assembly in the slot body, a height of the protective portion in a first direction is less than or equal to a height of the sensor assembly in the first direction, and the first direction is perpendicular to the first surface;
wherein the slot device further comprises a circuit board, the circuit board is disposed on the slot body, and the circuit board is electrically connected to the sensor assembly; and
wherein a long side and a short side of the protective portion are arranged around the sensor assembly.

12. The slot device according to claim 11, wherein the long side of the protective portion has an inclined surface, and the inclined surface is a surface close to the object inserted into the slot body.

13. The slot device according to claim 11, wherein the circuit board comprises an accommodation portion, the accommodation portion is formed by bending at least a part of the circuit board, the sensor assembly comprises a sensor, and the accommodation portion is configured to accommodate the sensor.

14. The slot device according to claim 13, wherein the slot body is provided with a placing portion, and the sensor assembly and the accommodation portion are disposed on the placing portion, and the placing portion has a groove or hollow shape.

15. The slot device according to claim 13, wherein the sensor assembly further comprises a first clamping member and a second clamping member, the first clamping member is disposed on the circuit board and located on a side of the circuit board close to the slot body, the second clamping member is disposed on the circuit board and located on a side of the circuit board away from the slot body, the first clamping member cooperates with the second clamping member to secure the sensor to the accommodation portion.

16. The slot device according to claim 15, wherein a width of the protective portion is greater than a width of the first clamping member or the second clamping member.

17. The slot device according to claim 16, wherein the width of the protective portion is more than twice the width of the sensor.

18. The slot device according to claim 11, wherein the slot body comprises a slot portion, the slot portion is in a form of an elongated rectangular body, the slot portion defines a slot for matching the object.

19. The slot device according to claim 18, wherein the slot body comprises a fixing portion, the fixing portion is disposed at both ends of the slot portion.

20. The slot device according to claim 19. wherein the fixing portion is configured to cooperate with the slot portion to fix the object inserted into the slot.
